(19) United States
(12) Patent Application Publication
(10) Pub. No.: US 2003/0225915 A1
(43) Pub. Date: Dec. 4, 2003

(54) Systems and methods for facilitating transactions between customers and providers via communication networks

(76) Inventors: Darrel Cherry, Boise, ID (US); James Clough, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/159,728

(22) Filed: May 29, 2002

(51) Int. Cl. G06F 15/16

(52) U.S. Cl. 709/250

(57) ABSTRACT

Systems for facilitating transactions between customers and providers of goods and/or services are provided. A representative system includes an e-service reference system that communicates with a communication network. The e-service reference system also acquires information corresponding to the provider and provides the information corresponding to the provider to the customer via the communication network. Methods, computer-readable media and other systems also are provided.

### BACKGROUND OF THE INVENTION

1. Field of the Invention

The present invention relates to communications networks and, more specifically, to systems and methods that facilitate transactions, such as the ordering of goods and/or services, between customers and providers via communication networks.

2. Description of the Related Art

The advent of computer networking and, in particular, the Internet, has made it possible to facilitate numerous transactions between entities in a relatively efficient manner. For instance, a merchant can use a Web site to advertise the sale of goods. This enables a consumer to view information about the goods that is displayed via the Web site as well as place an order for the goods. Clearly, this type of transaction is facilitated without the consumer having to travel to the merchant's place of business to view the goods. The consumer also may not need to interact directly with a representative of the merchant to place an order for the goods as the transaction may take place entirely electronically via the Web site.

As a more recent improvement, automated inventory control also has led to improvements in transaction efficiency. For example, sensors located in a warehouse can be used to determine whether particular inventory items are either in or out of stock. Once it is determined that an inventory item is out of stock, information can automatically be provided to an operator indicating the out-of-stock condition. The operator can then place an order for re-stocking the item without having to personally check in the warehouse for current inventory status.

An interesting situation occurs, however, when a good and/or service is to be ordered by a consumer, and the previous provider of the good and/or service is unavailable, e.g., out of business. In such a situation, a new provider typically must be identified. Traditionally, this is accomplished by the consumer obtaining provider referrals from other customers. Unfortunately, based upon the uniqueness of the goods and/or services required, and/or the amount of time available to locate an appropriate provider, the ability to identify a provider using a referral may be impractical.

Based on the foregoing, it should be appreciated that there is a need for improved systems and methods that address these and/or other perceived shortcomings of the prior art.

### SUMMARY OF THE INVENTION

The present invention involves systems and methods for facilitating transactions between customers and providers of goods and/or services. An embodiment of such a system includes an e-service reference system that communicates with a communication network. The e-service reference system also acquires information corresponding to the provider and provides the information corresponding to the provider to the customer via the communication network.

Another embodiment of a system in accordance with the invention incorporates an e-service reference system that provides a Web site. The Web site includes information corresponding to characteristics of providers and is accessible to customers via a communication network. Thus, a customer can locate a provider of goods and/or services that exhibits characteristics selected by the customer.

Yet another embodiment of a system in accordance with the invention includes means for acquiring information corresponding to characteristics of providers, means for receiving a request from a customer for at least one of a good and a service, and means for initiating contact between the customer and one of the providers about which information has been acquired.

At least some embodiments of an e-service reference system are stored on a computer-readable media. One such embodiment includes logic configured to acquire information corresponding to a provider, and logic configured to provide the information corresponding to the provider to a customer via a communication network.

E-service request systems also are provided that can be stored on computer-readable media. One such embodiment includes logic configured to receive information corresponding to characteristics that a customer requires a provider to exhibit if the provider is to provide at least one of a good and a service to the customer. The e-service request system also includes logic configured to receive, automatically, information corresponding to a need for ordering at least one of a good and a service, and logic configured to request, automatically, information corresponding to providers capable of providing the at least one of a good and a service, and which exhibit the characteristics that the customer requires.

Methods for facilitating a transaction between a customer and a provider are provided as well. In particular, one such embodiment includes: rating characteristics of multiple providers; providing a user with access to information corresponding to the characteristics rated; enabling the customer to select one of the providers about which information is provided and from which the customer desires to receive a good or service; and enabling the customer to contact the provider selected.

Another embodiment of a method in accordance with the invention includes: receiving information corresponding to characteristics that a customer requires a provider to exhibit if the provider is to provide at least one of a good and a service to the customer; automatically receiving information corresponding to a need for ordering at least one of a good and a service; and automatically requesting information corresponding to providers capable of providing the at least one of a good and a service, and which exhibit the characteristics that the customer requires.

### BRIEF DESCRIPTION OF THE DRAWINGS

The present invention, as defined in the claims, can be better understood with reference to the following drawings. The drawings are not necessarily to scale, emphasis instead being placed on clearly illustrating the principles of the present invention.

FIG. 1 is a schematic diagram depicting an embodiment of an e-service system of the present invention.

FIG. 2 is a flowchart depicting functionality of the embodiment of the e-service system of FIG. 1.

FIG. 3 is a schematic diagram depicting a computer or processor-based system that can be used to implement the embodiment of the e-service reference system of FIG. 1.

FIG. 4 is a flowchart depicting functionality of an embodiment of the e-service reference system of the present invention.

FIG. 5 is a flowchart depicting functionality of another embodiment of the e-service reference system of the present invention.

FIG. 6 is a schematic diagram depicting another embodiment of the e-service system of the present invention.

FIG. 7 is a flowchart depicting functionality of an embodiment of the e-service request system of FIG. 6.

FIG. 8 is a flowchart depicting functionality of another embodiment of the e-service request system of the present invention.

### DETAILED DESCRIPTION

As will be described in detail here, systems and methods of the invention provide customers with the ability to obtain information about providers of goods and/or services so that the customers can feel more confident about using a particular provider. Specifically, the information may be provided in the form of provider characteristics that are rated. These characteristics can pertain to numerous aspects of the providers, such as whether the provider carries insurance and/or whether product guarantees and price protection are offered, for example. Typically, the information is made accessible to a customer via a communication network, with the ratings of the various characteristics being compiled using customer feedback, provider responses and/or third party analysis of the providers.

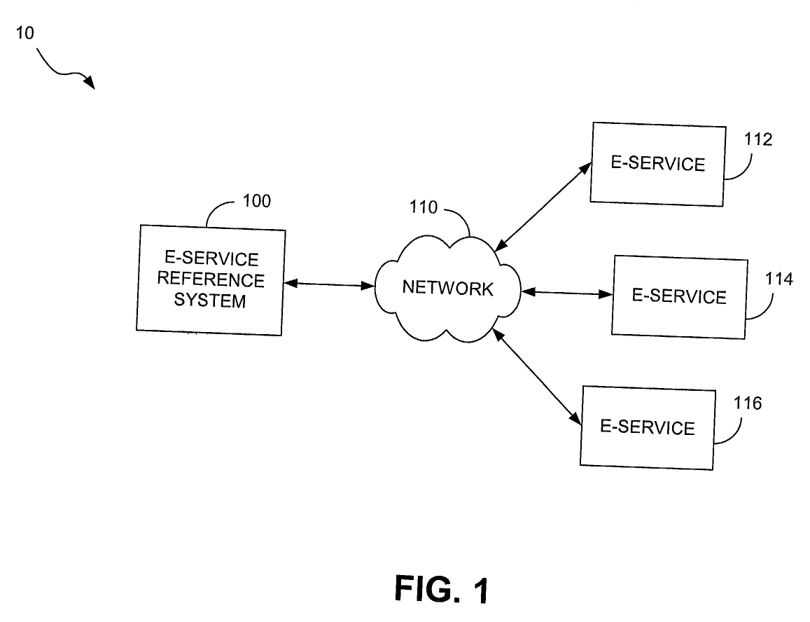

Referring now to the figures, wherein like reference numerals indicate corresponding components throughout the several views, FIG. 1 depicts a representative embodiment of an e-service system 10 of the present invention. As shown in FIG. 1, e-service system 10 includes an e-service reference system 100 that communicates with multiple e-service providers via a communication network 110. In particular, three e-service providers 112, 114 and 116 are depicted in FIG. 1 as communicating with the e-service reference system. Note, however, that various other numbers of e-service providers could be used.

As used herein, the term “e-service provider” refers to an entity that offers goods and/or services for sale via a communication network. This includes those entities that advertise and/or take orders for goods and/or services via Web sites. In this regard, a communication network, e.g., network 120, may be any type of communication network employing any network topology, transmission medium, or network protocol. For example, such a network may be any public or private packet-switched or other data network, including the Internet, circuit-switched networks, such as the public switched telephone network (PSTN), wireless network, or any other desired communications infrastructure and/or combination of infrastructures.

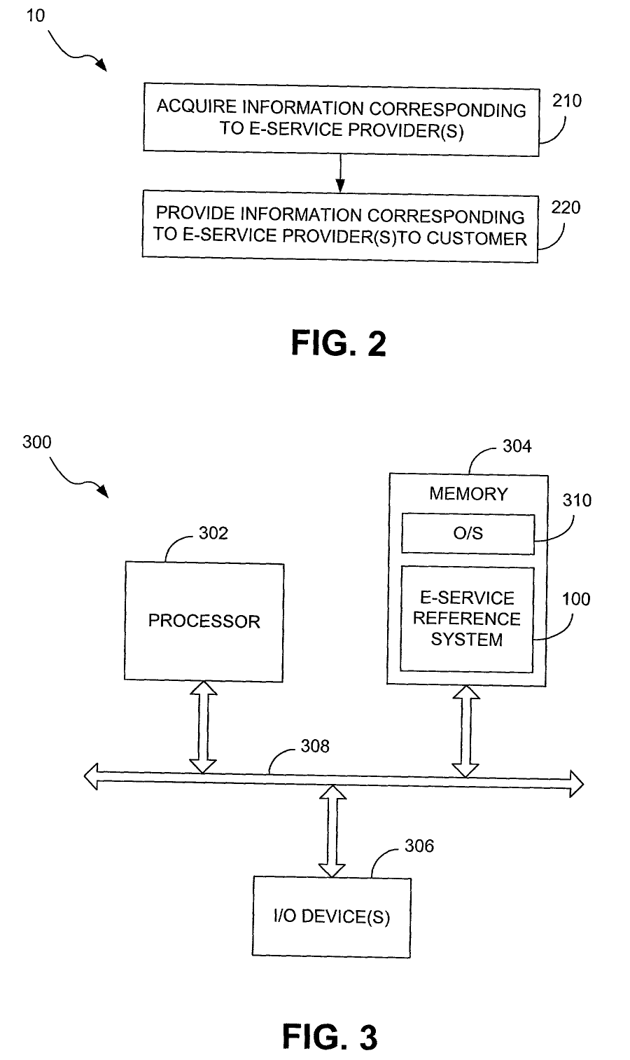

Functionality of the embodiment of the e-service reference system 100 of FIG. 1 is depicted in the flowchart of FIG. 2. As shown in FIG. 2, the functionality (or method) maybe construed as beginning at block 210, where information corresponding to one or more e-services is acquired. In particular, the information acquired corresponds to various characteristics of the providers that may be of interest to a potential customer. For instance, a customer may consider it useful to know whether the provider guarantees shipping dates for products, guarantees prices, maintains a substantial inventory for supporting large orders, and/or offers on-site technical support, among others. Clearly, the characteristics of interest would differ among the goods and/or services that are to be provided as would be known to one of ordinary skill in the art.

Typically, the information also includes a rating that can be associated with one or more of the characteristics. Such a rating could indicate the quality of a particular characteristic relative to a standard, e.g., the number of manufacturing defects per 1000 items could be posted. Additionally or alternatively, a rating could indicate the quality of a particular characteristic relative to other providers, in which case the rating would serve as an indication of rank among competing providers.

Information regarding the various characteristics can be compiled using various sources. By way of example, provider responses to inquiries, e.g., questionnaires, may be used to determine certain information, such as whether price guarantees are offered. For instance, the e-service reference system can post a questionnaire to a Web site that can be used to acquire information from an e-service provider that would desire to have information about their services provided to customers via the e-service reference system.

Additionally or alternatively, information about a provider that is acquired by a third party can be used. For example, credit information could be acquired from various independent entities. Feedback regarding a particular provider also can be provided by customers that have used the provider. For instance, information regarding customer service responsiveness could be obtained. Clearly, various methods can be used to obtain information.

Returning back to the flowchart of FIG. 2, once information has been obtained, at least some of the information corresponding to one or more of the e-services is provided (block 220), e.g., provided for access by a customer. Typically, this is accomplished by enabling a customer to access the information via a Web site associated with the e-service reference system.

E-service reference systems 100 can be implemented in software, firmware, hardware, or a combination thereof. When implemented in hardware, e-service reference system 100 can be implemented with any or a combination of various technologies. By way of example, the following technologies, which are each well known in the art, can be used: a discrete logic circuit(s) having logic gates for implementing logic functions upon data signals, an application specific integrated circuit (ASIC) having appropriate combinational logic gates, a programmable gate array(s) (PGA), and a field programmable gate array (FPGA).

When implemented in software, e-service reference system 100 can be a program that is executable by a digital computer, an example of which is depicted schematically in FIG. 3. In FIG. 3, computer 300 includes a processor 302, memory 304, and one or more input and/or output (I/O) devices 306 (or peripherals) that are communicatively coupled via a local interface 308. Local interface 208 can be, for example, one or more buses or other wired or wireless connections, as is known in the art.

Processor 302 can be a hardware device configured to execute software that can be stored in memory 304. Memory 304 can include any combination of volatile memory elements (e.g., random access memory (RAM, such as DRAM, SRAM, etc.)) and/or nonvolatile memory elements (e.g., ROM, hard drive, tape, CDROM, etc.). Moreover, memory 304 can incorporate electronic, magnetic, optical, and/or other types of storage media. Note that memory 304 can have a distributed architecture, where various components are situated remote from one another, but can be accessed by processor 302.

The software in memory 304 can include one or more separate programs, each of which comprises an ordered listing of executable instructions for implementing logical functions. The software in the memory 304 includes e-service reference system 100 and a suitable operating system (O/S) 310. The operating system 310 controls the execution of other computer programs, such as e-service reference system.

The I/O device(s) 306 can include input devices such as a keypad, for example. I/O device(s) 306 also can include output devices such as a display device or speaker, for example. I/O device(s) 306 may further include devices that are configured to communicate both inputs and outputs such as a touch screen display.

When e-service reference system 100 is implemented in software, it should be noted that the e-service reference system can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. E-service reference system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

As used herein, a “computer-readable medium” can be any means that can store, communicate, propagate or transport a program for use by or in connection with an instruction execution system, apparatus, or device. Thus, a computer readable medium can be, for example but not limited to, an electronic, magnetic, optical, electromagnetic, infrared, or semiconductor system, apparatus, device, or propagation medium. More specific examples (a nonexhaustive list) of a computer-readable medium include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program could be electronically captured, via optical scanning of the paper or other medium, then compiled, interpreted or otherwise processed in a suitable manner, if necessary, and then stored in a computer memory.

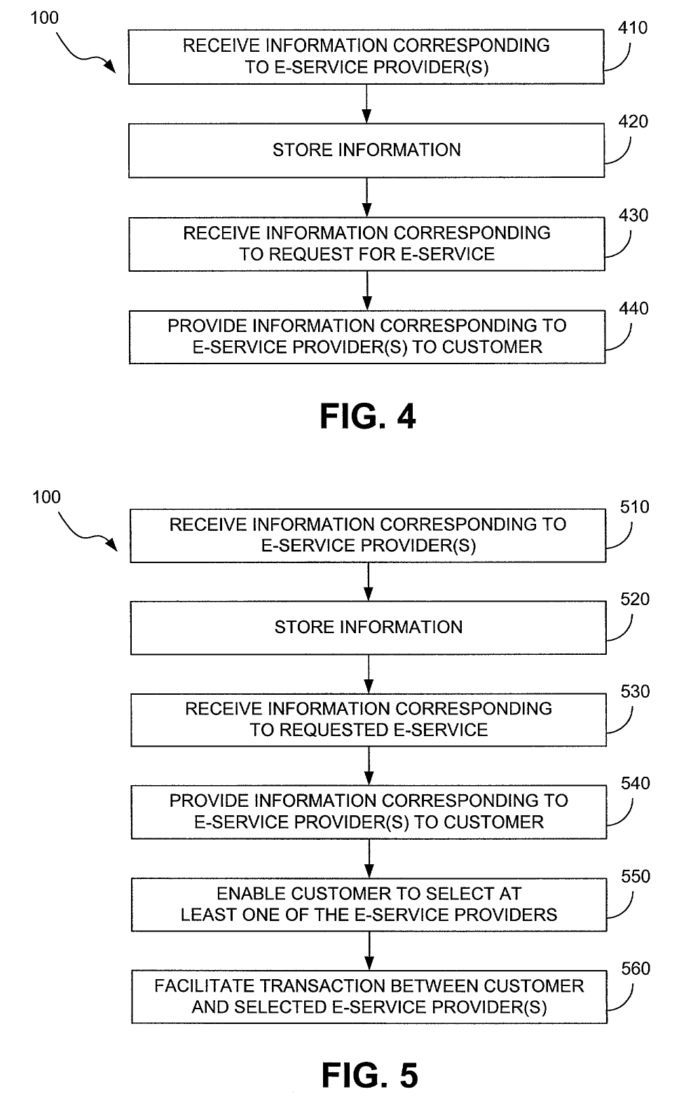

Reference will now be made to the flowchart of FIG. 4, which depicts the functionality of a representative embodiment of e-service reference system 100 of the invention. In this regard, each block of the flowchart represents a module segment or portion of code that comprises one or more executable instructions for implementing the specified logical function(s). It should also be noted that in some alternative implementations the functions noted in various blocks of FIG. 4, or any other of the accompanying flowcharts, may occur out of the order in which they are depicted. For example, two blocks shown in succession in FIG. 4 may, in fact, be executed substantially concurrently. In other embodiments, the blocks may sometimes be executed in the reverse order depending upon the functionality involved.

As shown in FIG. 4, the functionality (or method) may be construed as beginning at block 410, where information corresponding to one or more e-service providers is received. In block 420, information corresponding to one or more of the e-service providers is stored, such as by a server. In block 430, information corresponding to a request for an e-service provider is received. More specifically, such a request typically is received from a potential a customer inquiring as to the availability of a particular good and/or service. Thereafter, such as depicted in block 440, information corresponding to one or more e-service providers that are capable of providing the requested good and/or service is provided to the customer. As mentioned before, this can be accomplished by providing the customer with access to the information, such as via a Web site or other electronically facilitated process, e.g., e-mail.

Functionality of another representative embodiment of an e-service reference system 100 is depicted in FIG. 5. As shown in FIG. 5, the functionality (or method) may be construed as beginning at block 510, where information corresponding to one or more e-service providers is received. In block 520, information corresponding to the one or more e-services is stored. In block 530, information corresponding to a request for a good and/or service is received from a potential customer. Thereafter, such as depicted in block 540, information corresponding to one or more e-service providers that are capable of providing the requested good and/or service is provided to the customer.

In response to receipt of the information corresponding to the e-service providers, the customer can select at least one of the e-service providers with which it is desirous of conducting a transaction (block 550). In block 560, a transaction between the customer and the selected e-service provider is facilitated. By way of example, the customer may be directed to contact the selected e-service provider directly to initiate the transaction. This can be accomplished, for instance, by the e-service reference system providing a link via a Web site to the selected e-service provider. As another example, contact information, e.g., a phone number, email address and/or mailing address, could be provided to the customer and/or selected e-service provider so that either can initiate contact.

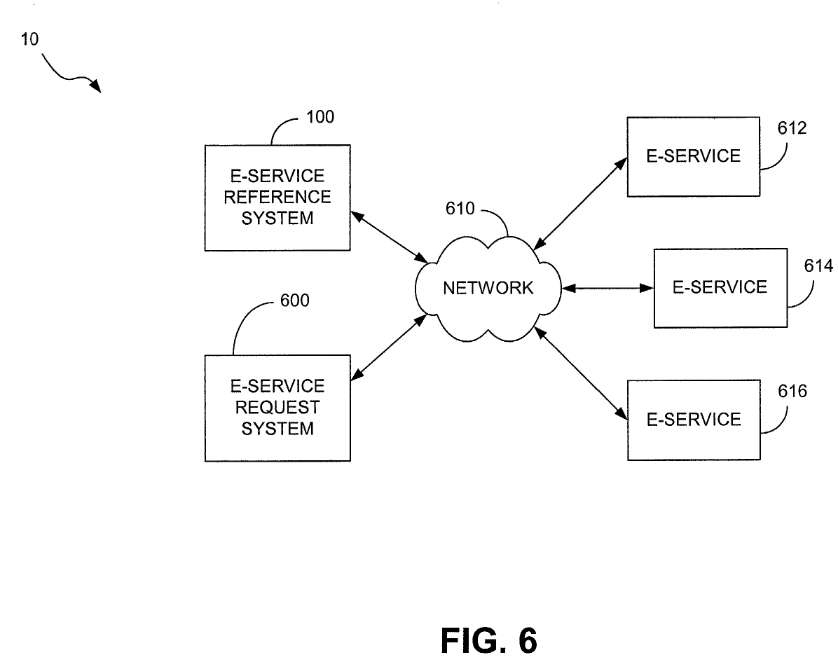

Preferably, the transaction between the customer and the selected e-service provider is carried out automatically. That is, once a particular e-service provider is selected, the process of transferring information between the customer and the e-service provider is completed without the necessary intervention of an operator. In some embodiments, the entire process of establishing contact with an e-service reference system, selecting an e-service provider, and completing a transaction with a selected e-service provider is accomplished automatically. An embodiment of an e-service system 10 that is capable of conducting the aforementioned exemplary transaction automatically is depicted schematically in FIG. 6.

As shown in FIG. 6, e-service system 10 includes an e-service reference system 100 that communicates with an e-service request system 600 as well as with multiple e-service providers, via a communication network 610. In particular, three e-service providers 612, 614 and 616 are depicted in FIG. 6 as communicating with both the e-service reference system and the e-service request system. Note, however, that various other numbers of e-service providers could be used.

E-service request system 600 is used to request-information about e-service providers from e-service reference system 100. For instance, when an e-service request system receives information indicating that a particular good is about to go out of stock, system 600 can automatically establish communication with an e-service reference system and inquire about e-service providers that offer the needed good.

E-service request systems 600 also can be used to select among various e-service providers about which the e-service reference system provides information. Typically, the e-service request system receives inputs from an operator that establishes criteria against which e-service providers are compared. For example, an operator can provide information that requires an e-service provider to carry insurance before that service provider is considered authorized for selection. Thus, if an e-service provider does not carry insurance, as indicated by information provided by the e-service reference system, the e-service request system should not be able to initiate a transaction with that e-service provider.

Initiation of the desired transaction can be facilitated by the e-service request systems 600. In some embodiments, this also can be accomplished automatically. That is, once the e-service request system receives information regarding the particular e-service provider that meets the established criteria, the e-service request system can contact that provider, such as via the Internet, and place the appropriate request, e.g., the required order.

Much like the e-service reference system, embodiments of the e-service request system 600 can be implemented in software, firmware, hardware, or a combination thereof. Such implementations, therefore, will not be described again.

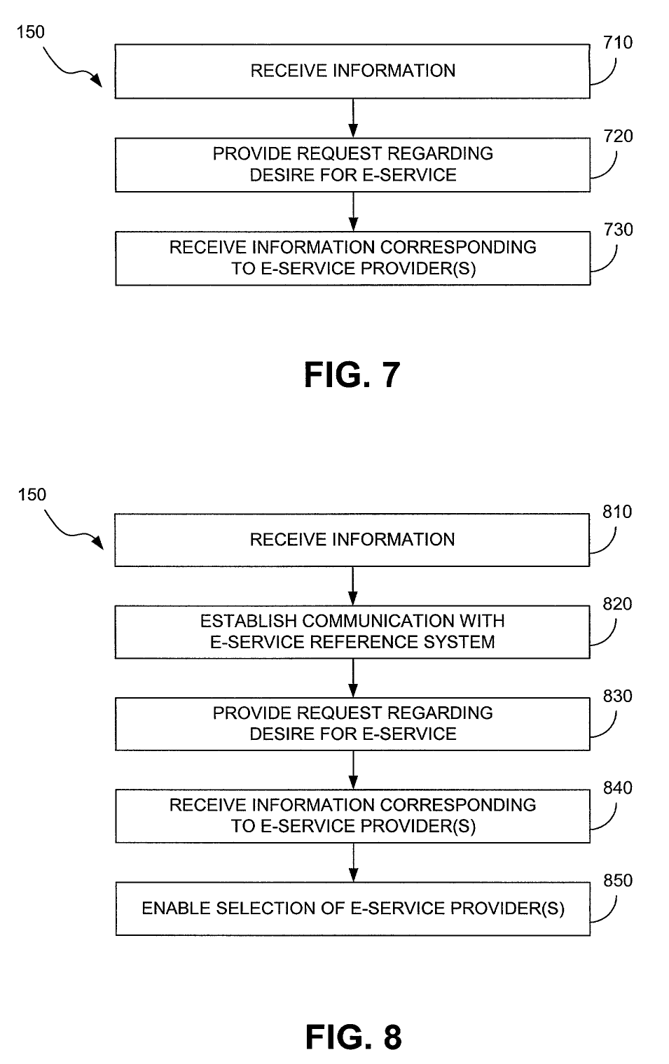

Functionality of an embodiment of an e-service request system will now be described with reference to the flowchart of FIG. 7. As shown in FIG. 7, the functionality (or method) may be construed as beginning at block 710, where information is received. In particular, the information may correspond to the need for goods and/or services. For instance, the information could indicate that a particular good is running low in inventory. Thereafter, such as depicted in block 720, a request regarding a desire for a corresponding e-service provider to fulfill this identified need is provided. In particular, such a request may be provided to an e-service reference system.

Proceeding to block 730, information corresponding to one or more e-service providers that may be able to provide the requested service(s) is received. Once received, a transaction can be initiated with a selected e-service provider to place an order for the required good, for example. Note, if, based on established selection criteria, an e-service reference system is not able to provide information corresponding to at least one e-service provider to the customer, the e-service reference system may prompt the customer to modify the established selection criteria. In response to the prompt, the customer may decide that e-service providers do not have to offer on-site technical support, for example, to be eligible for selection. Based on this revised criteria, the e-service reference system may be able to provide the customer with one or more e-service providers from which to select.

Functionality of another embodiment of an e-service request system is depicted in the flowchart of FIG. 8. As shown in FIG. 8, the functionality (or method) may be construed as beginning at block 810, where information corresponding to a need for goods and/or services is received. By way of example, the information can be received from an automated inventory system (described before). In block 820, communication with an e-service reference system is established, e.g., automatically established. Thereafter, such as depicted in block 830, a request regarding a desire for goods and/or services is provided to the e-service reference system. In block 840, information corresponding to one or more e-service providers that are capable of providing the requested goods and/or services is received. In block 850, selection of one or more of the e-services is enabled. In some embodiments, selection of an e-service provider is accomplished automatically by referencing criteria, e.g., particular characteristics and/or threshold levels of ratings provided by the e-service reference system, that was previously established and input to the e-service request system. Once a selection is made, a transaction can be initiated, such as automatically by the e-service request system or by an operator.

The foregoing description has been presented for purposes of illustration and description. It is not intended to be exhaustive or to limit the invention to the precise forms disclosed. Modifications or variations are possible in light of the above teachings. The embodiment or embodiments discussed, however, were chosen and described to provide an illustration of the principles of the invention and its practical application to thereby enable one of ordinary skill in the art to utilize the invention in various embodiments and with various modifications as are suited to the particular use contemplated. All such modifications and variations, are within the scope of the invention as determined by the appended claims when interpreted in accordance with the breadth to which they are fairly and legally entitled.

1. A system for facilitating a transaction between a customer and a provider, the provider offering at least one of goods and services via a communication network, said system comprising:
an e-service reference system operative to:
communicate with the communication network;
acquire information corresponding to the provider; and
provide the information corresponding to the provider to the customer via the communication network.

2. The system of claim 1, wherein the provider is a first provider among multiple providers; and
wherein said e-service reference system is further operative to receive information corresponding to a request from the customer for at least one of a good and a service via the communication network and, in response to the request, provide the customer with information corresponding to those of the multiple providers capable of providing at least one of the good and the service requested.

3. The system of claim 2, wherein said e-service reference system is further operative to enable the customer to select a provider from among those of the multiple providers capable of providing at least one of the good and the service requested.

4. The system of claim 3, wherein said e-service reference system is further operative to facilitate a transaction between the provider selected and the customer.

5. The system of claim 4, wherein said e-service reference system interfaces with the customer via a Web site, said Web site including a hyperlink to a provider Web site associated with the provider selected to facilitate the transaction such that the customer can activate the hyperlink to contact the provider selected.

6. The system of claim 4, wherein said e-service reference system provides the customer with at least one of a phone number, an email address and a mailing address associated with the provider selected.

7. The system of claim 1, further comprising:
an e-service request system operative to:
communicate with said e-service reference system via the communication network;
receive information corresponding to a request for at least one of a good and a service; and
provide the request for the at least one of a good and a service to said e-service reference system.

8. The system of claim 7, wherein said e-service request system is further operative to receive information corresponding to providers capable of providing the at least one of a good and a service requested, and enable the customer to select the provider with which the customer desires to conduct a transaction.

9. A system for facilitating a transaction between a customer and a provider, the provider offering at least one of goods and services via a communication network, said system comprising:
an e-service reference system adapted for providing a Web site, said Web site including information corresponding to characteristics of providers, said Web site being accessible by customers via the communication network such that a customer can locate a provider of a least one of a good and a service that exhibits characteristics selected by the customer.

10. The system of claim 9, further comprising:
an e-service request system adapted to:
receive information corresponding to characteristics selected by the customer;
receive information corresponding to a request for at least one of a good and a service;
communicate with said e-service reference system via the communication network such that said e-service reference system is informed of said request.

11. The system of claim 10, wherein, in response to said request, said e-service reference system provides information corresponding to providers capable of providing the at least one of a good and a service requested to the customer, the providers exhibiting the characteristics selected by the customer.

12. A system for facilitating a transaction between a customer and a provider, said system comprising:
means for acquiring information corresponding to characteristics of providers;
means for receiving a request from a customer for at least one of a good and a service; and
means for initiating contact between the customer and one of the providers about which information has been acquired.

13. The system of claim 12, further comprising:
means for enabling the customer to select one among providers capable of providing at least one of the good and the service requested.

14. The system of claim 12, further comprising:
means for identifying a need for requesting at least one of the good and the service.

15. A method for facilitating a transaction between a customer and a provider, the provider offering at least one of goods and services via a communication network, said method comprising:
rating characteristics of multiple providers;
providing a user with access to information corresponding to the characteristics rated;
enabling the customer to select at least one of the providers about which information is provided and from which the customer desires to receive at least one of a good and a service; and
enabling the customer to contact the provider selected.

16. The method of claim 15, wherein, in rating the characteristics of multiple providers, information is acquired from at least one of former customers of a provider, a provider and other entities.

17. The method of claim 15, wherein rating the characteristics of multiple providers comprises:
providing a Web site; and
receiving information regarding the characteristics of the multiple providers via the Web site.

18. A method for facilitating a transaction between a customer and a provider, the provider offering at least one of goods and services via a communication network, said method comprising:
receiving information corresponding to characteristics that a customer requires a provider to exhibit if the provider is to provide at least one of a good and a service to the customer;
automatically receiving information corresponding to a need for ordering at least one of a good and a service; and
automatically requesting information corresponding to providers capable of providing the at least one of a good and a service, and which exhibit the characteristics that the customer requires.

19. The method of claim 18, wherein the characteristics include at least one of:
business insurance, guaranteed shipping dates, on-site technical support and product warrantees.

20. An e-service request system stored on a computer-readable medium for facilitating a transaction between a customer and a provider, the provider offering at least one of goods and services via a communication network, said e-service request system comprising:
logic configured to receive information corresponding to characteristics that a customer requires a provider to exhibit if the provider is to provide at least one of a good and a service to the customer;
logic configured to receive, automatically, information corresponding to a need for ordering at least one of a good and a service; and
logic configured to request, automatically, information corresponding to providers capable of providing the at least one of a good and a service, and which exhibit the characteristics that the customer requires.

21. The e-service request system of claim 20, further comprising:
logic configured to enable the customer to update the information corresponding to the characteristics that the customer requires a provider to exhibit.

22. An e-service reference system stored on a computer-readable medium for facilitating a transaction between a customer and a provider, the provider offering at least one of goods and services via a communication network, said e-service reference system comprising:
logic configured to acquire information corresponding to the provider; and
logic configured to provide the information corresponding to the provider to the customer via the communication network.

23. The e-service reference system of claim 22, wherein the provider is a first provider among multiple providers; and
further comprising:
logic configured to receive information corresponding to a request from the customer for at least one of a good and a service via the communication network; and
logic configured to provide the customer with information corresponding to those of the multiple providers capable of providing at least one of the good and the service requested in response to the request.

24. The e-service reference system of claim 23, further comprising:
logic configured to enable the customer to select one among those of the multiple providers capable of providing at least one of the good and the service requested.

25. The e-service reference system of claim 24, further comprising:
logic configured to facilitate a transaction between the one of the multiple providers selected and the customer.
